(19) United States
(12) Patent Application Publication
(10) Pub. No.: US 2017/0322513 A1
(43) Pub. Date: Nov. 9, 2017

(54) Holographic Multimedia Presentation and Projector

(71) Applicant: Edgardo G. Zapanta, San Bruno, CA (US)

(72) Inventor: Edgardo G. Zapanta, San Bruno, CA (US)

(21) Appl. No.: 15/147,187

(22) Filed: May 5, 2016

(51) Int. Cl. G03H 1/00; G03H 1/02; G02B 5/32; G03H 1/08; G03H 1/22; G03H 1/28

(52) U.S. Cl. CPC G03H 1/00; G03H 1/2202; G03H 1/0236; G03H 1/0276; G03H 1/28; G02B 5/32; G03H 1/0891; G03H 2001/0088; G03H 2001/0232; G03H 2001/0296

(57) ABSTRACT

A method for creating a holographic multimedia presentation and a system for projecting the presentation. A multimedia presentation is created by simultaneously projecting 4 rotated identical images from the screen of a flat panel mobile handheld device such as a phone or tablet to a focal location within an inverted, 4-sided pyramid-shaped holographic image projector. The inverted, 4-sided pyramid-shaped holographic image projector is formed out of transparent, semi-rigid acrylic or other plastic or glass, and the four triangular sides are joined with a live hinge, also made of transparent material, such that the projector can be stored and transported in a flat, folded configuration and can be used for viewing holographic multimedia video presentations when in a folded position.

### FIELD OF THE INVENTION

The present invention is a method for creating a holographic multimedia presentation and a novel system for projecting the presentation.

### BACKGROUND OF THE INVENTION

FIG. 1-A (prior art) shows the optical illusion in many magic tricks is often one based on the illusion known as “Pepper's Ghost”. A viewer (not shown) looking through a front rectangular set 14 into a main room 16 sees an image 12 of an object 10 floating in the room. The illusion is produced by a large piece of glass, Plexiglas or plastic film 18 situated at an angle between the viewer and the scene. The glass 18 reflects a side room 19 hidden from the viewer, i.e., on the left, sometimes called a “blue room”, that is built as a mirror-image of the main room ‘16. If the mirror-image hidden room 19 on the left is darkened, objects 10 inside the hidden room do not reflect well in the glass 18. If the empty main room 16 is brightly lit, it very is visible to the viewer. However, when the lights in the mirror-image room 19 are raised, with the main empty room 16 being dimmed slightly to compensate, the image 12 of object(s) 10 in the hidden room 19 appears out of nowhere as if floating in space. https://en.wikipedia.org/wiki/Pepper's_ghost

A reflector sight or reflex sight is an optical device that allows the user to look through a partially reflecting glass element and see an illuminated projection of an aiming point or some other image superimposed on the field of view. These sights work on the simple optical principle that anything at the focus of a lens or curved mirror, such as an illuminated reticle, will look like it is sitting in front of the viewer at infinity. Reflector sights employ some sort of “reflector” to allow the viewer to see the infinity image and the field of view at the same time, either by bouncing the image created by lens off a slanted glass plate, or by using a mostly clear curved glass reflector that images the reticle while the viewer looks through the reflector. Since the reticle is at infinity it stays in alignment with the device the sight is attached to regardless of the viewer's eye position, removing most of the parallax and other sighting errors found in simple sighting devices.

FIG. 1-B (prior art) is a diagram of three types of reflector sights. The top type I uses a collimating lens CL and a beam splitter B to create a virtual image at infinity V of a reticle R. The bottom two types II and III use half silvered curved mirrors CM as the collimating optics. https://en.m.wikipedia.org/wiki/Reflector_sight#Other_uses

A stereoscope is a device for viewing a stereoscopic pair of separate images, depicting left-eye and right-eye views of the same scene, as a single three-dimensional image. This is the basis for many scientific, gaming and entertainment applications enhanced by virtual-reality (VR) technology. https://en.wikipedia.org/wiki/Stereoscope

### SUMMARY OF INVENTION AND ADVANTAGES

The present invention is a unique method for creating a holographic multimedia presentation, wherein a software application such as Microsoft PowerPoint™ or Paint can be used.

The present invention has application in presentation of social media content like “Skype”, “Facetime”, “Viber”, “Facebook” and “Twitter” wherein there are two (2) devices. First is a small mobile device such as a hand-held phone, tablet or laptop that holds the App. The other is a large OLED or other flat screen monitor laid flat on a surface, with 4 images projected therefrom. The mobile device and the flat screen monitor are connected together by a “cable” or using a mobile device built-in or installed “Screen Mirroring” option or App. A 4× hologram triangle projector pyramid or other holographic pyramid projector is mounted above the monitor. The hologram pyramid can be made by cutting thin, highly glossy reflective transparent acrylic sheets and assembling them together with clear plastic adhesive tape.

Hologram videos can be made using computer software editing tools like Paint™, Microsoft PowerPoint™, downloaded home videos of any subject or YouTube videos, Facetime videos, etc. Making the hologram video requires use of the image editing software tools. In one embodiment of the present invention, there are four (4) identical images or videos displayed on a “Black” background. The video is played simultaneously in 4 equal shapes on a smart phone or other mobile OLED device. The image/video is projected at 45° on a highly reflective hologram inverted pyramid surface. With the arrangement of the four (4) images or video images the holographic presentation can be viewed in 360 degrees. This gives the presentation an virtual reality (V.R.)-like, immersive experience illusion of a 3D image or video floating on air.

The present invention is a technique of using image and video editing tools to make image or video content. A “black” or dark background works best because it has no reflection, if there's text it can be “flipped” or “reversed”. It can be copied four (4) times with the copies arranged equally in a pattern by rotating them. When the four (4) videos are played at the same time, they can then be saved with a movie file extension such as .AVI, .WMV, etc.

The present invention is a method to enlarge a rectangular “portrait” or “landscape” size image/video by “cropping” the edges into a triangle at 45°. In this manner, the projected image/video is in a shape of a triangle.

Further, a reflecting mirror can be placed at a 45° under the mobile/laptop device laid horizontal. Using a built-in or downloaded “kaleidoscope” camera option in the mobile/laptop device, it is possible to produce an instant moving holographic image. The reflecting mirror can be produced for use on any type of mobile handheld telephone or other computing device.

The present invention is an App for a mobile device use of interactive social media like Skype, Webex, Viber, Facebook chat, Ok Google, Siri interactive and other search engines, etc. The holographic presentation can be in the shape of a floating sphere or other form for holographic-augmented video presentations for visual, interactive entertainment.

Benefits and features of the invention are made more apparent with the following detailed description of a presently preferred embodiment thereof in connection with the accompanying drawings, wherein like reference numerals are applied to like elements.

### BRIEF DESCRIPTION OF THE DRAWINGS

FIG. 1-A (prior art) shows the optical illusion in many magic tricks is often one based on the illusion known as “Pepper's Ghost”.

FIG. 1-B (prior art) is a diagram of three types of reflector sights.

FIG. 2-A shows a representative screenshot 100 from a software application that creates multimedia presentations.

FIG. 2-B shows a screenshot from the multimedia presentation software application and a dialog box 20 wherein a predetermined slide size is selected.

FIG. 3 shows a screenshot from the multimedia presentation software application from which a black background is selected.

FIG. 4 shows a screenshot from the multimedia presentation software application of a hologram slide 40.

FIG. 5 shows a representative screenshot from a software application that creates multimedia presentations in which the hologram slide 40 is copied 4 times and rotated to create a quadraplex image 50.

FIG. 6 shows a representative screenshot from a software application that creates multimedia presentations in which an image is inserted into each of the 4 portions of the quadraplex image 50.

FIG. 7 shows a screenshot from the multimedia presentation software application of a hologram video slide 70.

FIG. 8 shows a screenshot from the multimedia presentation software application of a hologram video slide 70 that has been shaped.

FIG. 8-A shows a screenshot from the multimedia presentation software application of a hologram video slide 70 in the shape of a sphere.

FIG. 9 shows a representative screenshot from a software application that creates multimedia presentations in which the shaped hologram video slide 72 is copied 4 times and rotated to create a quadraplex video image 90.

FIG. 9-B shows a representative screenshot from a software application that creates multimedia presentations in which the hologram video slide 72 in the shape of a sphere is copied 4 times and rotated to create a quadraplex video image 90.

FIG. 10 shows a representative screenshot from a software application that creates multimedia presentations in which the quadraplex video image 90 is viewed through the animation control pane 92.

FIG. 11 is a representative screenshot from a software application that creates multimedia presentations in which the animated quadraplex video image 92 can be saved as a WMV or other video/movie file extension.

FIG. 12-A is a representative top view of an unfolded 4× hologram triangle projector pyramid 1100 of the present invention.

FIG. 12-B is a representative side view of one (1) of the four (4) equivalent-shaped triangles sides 1102 of the 4× hologram triangle projector pyramid 1100 of the present invention.

FIG. 12-C is a representative top view of an assembled 4× hologram triangle projector inverted pyramid 1200 of the present invention.

FIG. 12-D is a representative side view of an assembled 4× hologram triangle projector inverted pyramid 1200 of the present invention taken at section A-A.

FIG. 12-E is a representative front view of an assembled 4× hologram triangle projector inverted pyramid 1200 of the present invention taken at section B-B.

FIG. 13-A is a representative orthogonal view of an assembled 4× hologram triangle projector inverted pyramid 1200 of the present invention in alignment with a flat screen holographic multimedia presentation player 1300 of the present invention.

FIG. 13-B is a representative orthogonal view of an assembled 4× hologram triangle projector inverted pyramid 1200 of the present invention mounted onto a flat screen holographic multimedia presentation player 1300 of the present invention.

FIG. 13-C is a representative orthogonal view of a folded 4× hologram triangle projector pyramid 1200 of the present invention mounted onto a flat screen holographic multimedia presentation player 1300 of the present invention.

FIG. 14-A is a representative orthogonal view of a method of use of the 4× hologram triangle projector inverted pyramid 1200 of the present invention and a flat screen holographic multimedia presentation player 1300 of the present invention.

FIG. 14-B is a detail view of a 45° selfie mirror 1400 used with a flat screen holographic multimedia presentation player 1300 of the present invention.

FIG. 14-C is a side view of a method of use of the 4× hologram triangle projector inverted pyramid 1200 of the present invention and a flat screen holographic multimedia presentation player 1300 of the present invention.

FIG. 14-D is another representative view of a method of use of the 4× hologram triangle projector pyramid 1200 of the present invention with a flat screen holographic multimedia presentation player 1300 of the present invention.

FIG. 14-E is a representative view of a method of use of a privacy screen 1410 disposed between the 4× hologram triangle projector pyramid 1200 of the present invention and the flat screen holographic multimedia presentation player 1300 of the present invention.

FIGS. 14-F and 14-G are orthogonal and side views, respectively, of a method of use of the 4× hologram triangle projector inverted pyramid 1200 of the present invention and a flat screen holographic multimedia presentation player 1300 of the present invention for performing voice activated searches on the internet using a search engine 1450 as desired.

FIGS. 14-H and 14-I are orthogonal and side views, respectively, of a method of use of the 4× hologram triangle projector inverted pyramid 1200 of the present invention and a flat screen holographic multimedia presentation player 1300 of the present invention for voice activated accessing of websites 1460 on the internet as desired.

FIGS. 14-J and 14-K are orthogonal and side views, respectively, of a method of use of the 4× hologram triangle projector inverted pyramid 1200 of the present invention and a flat screen holographic multimedia presentation player 1300 of the present invention for voice activated video 1470 control as desired.

FIGS. 14-L and 14-M are orthogonal and side views, respectively, of a method of use of the 4× hologram triangle projector inverted pyramid 1200 of the present invention and a flat screen holographic multimedia presentation player 1300 of the present invention for voice activated accessing of social media apps 1480 as desired.

FIG. 14-N is an orthogonal view of a method of use of the 4× hologram triangle projector inverted pyramid 1200 of the present invention and a flat screen holographic multimedia presentation player 1300 of the present invention for two (2) or more individuals or entities to interact as desired via social media apps.

FIGS. 14-O and 14-P are orthogonal and side views, respectively, of a method of use of the 4× hologram triangle projector inverted pyramid 1200 of the present invention and a flat screen holographic multimedia presentation player 1300 of the present invention for two (2) or more individuals or entities to interact as desired via video chat apps.

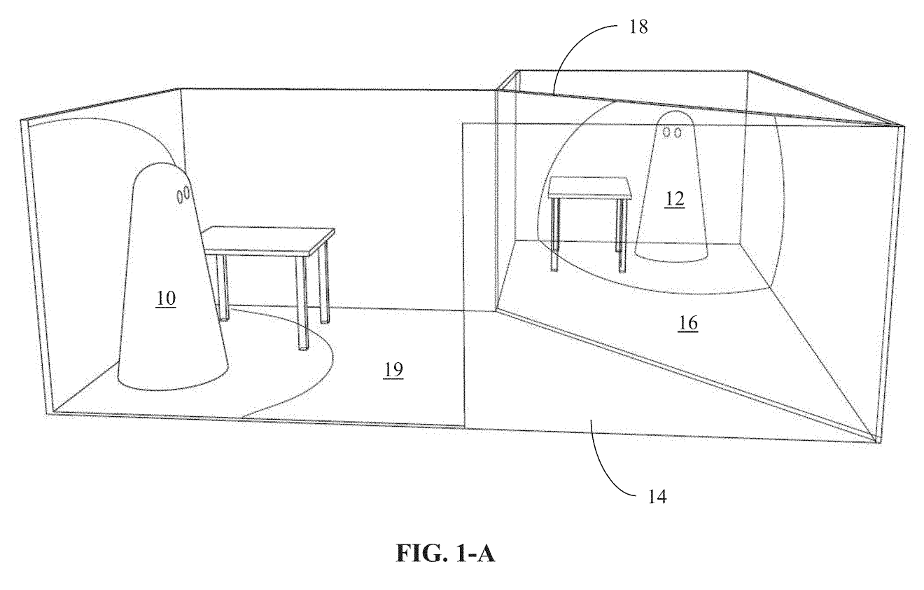

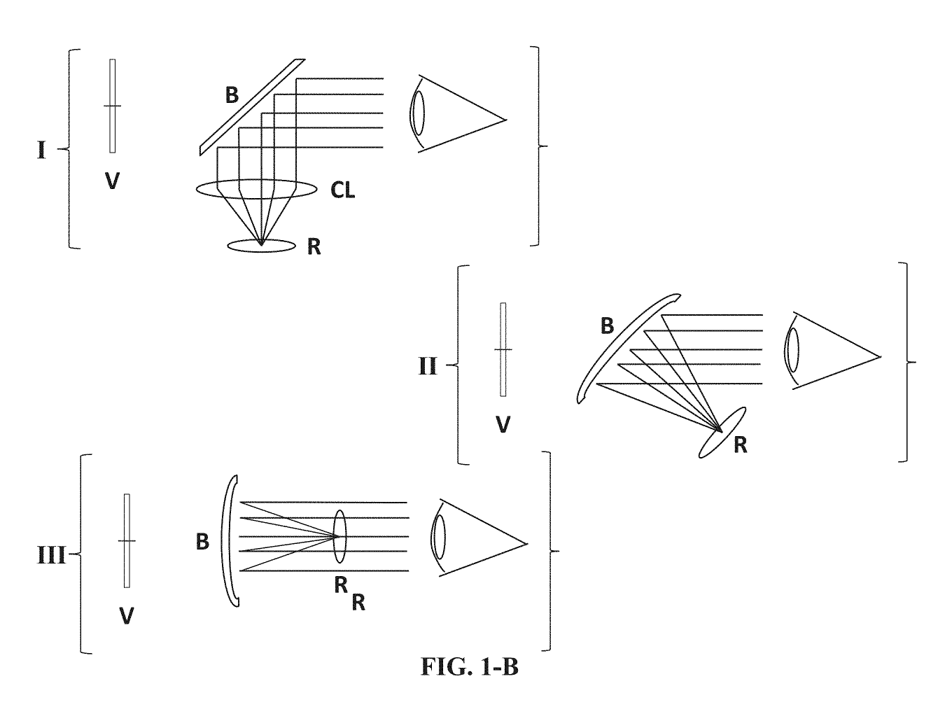

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

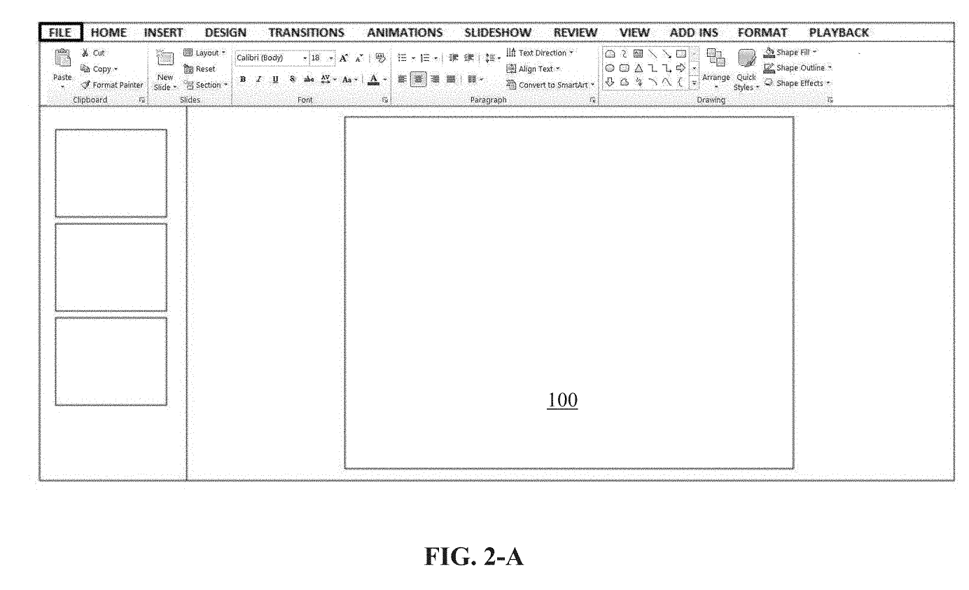

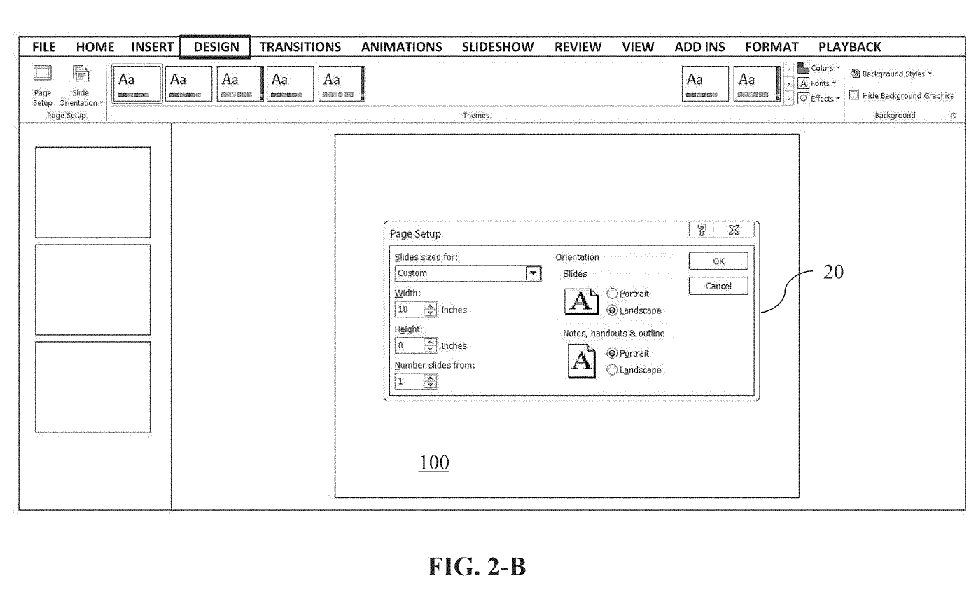

FIG. 2-A shows a representative screenshot 100 from a software application that creates multimedia presentations.

FIG. 2-B shows a screenshot from the multimedia presentation software application and a dialog box 20 wherein a predetermined slide size is selected. In a preferred embodiment, the size of the slide is set to be 12 inches by 10 inches.

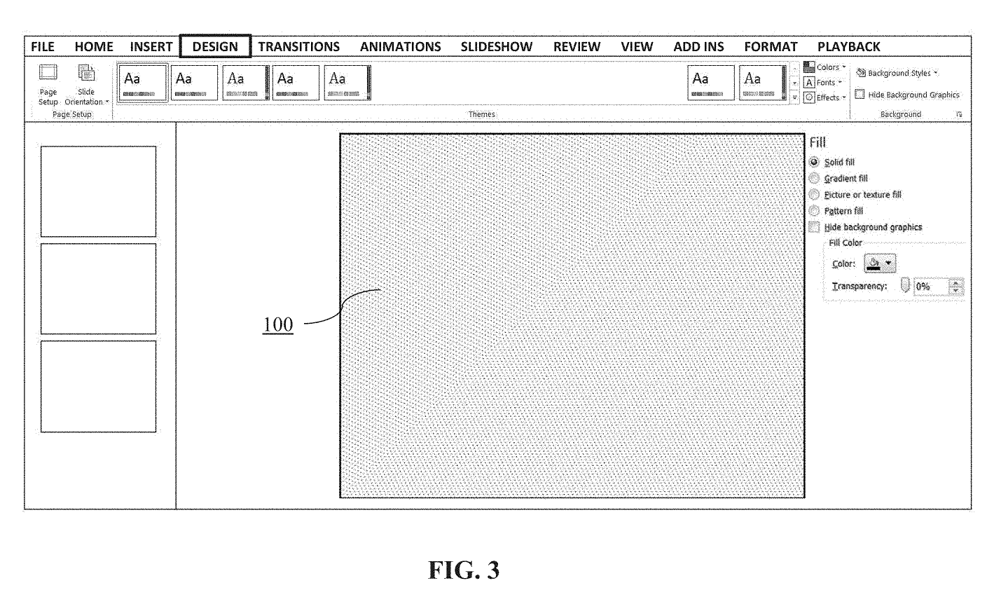

FIG. 3 shows a screenshot from the multimedia presentation software application from which a black background 102 is selected. The background 102 can be formatted “black”. Click Format, Background, Solid fill, Color: “Black” as shown.

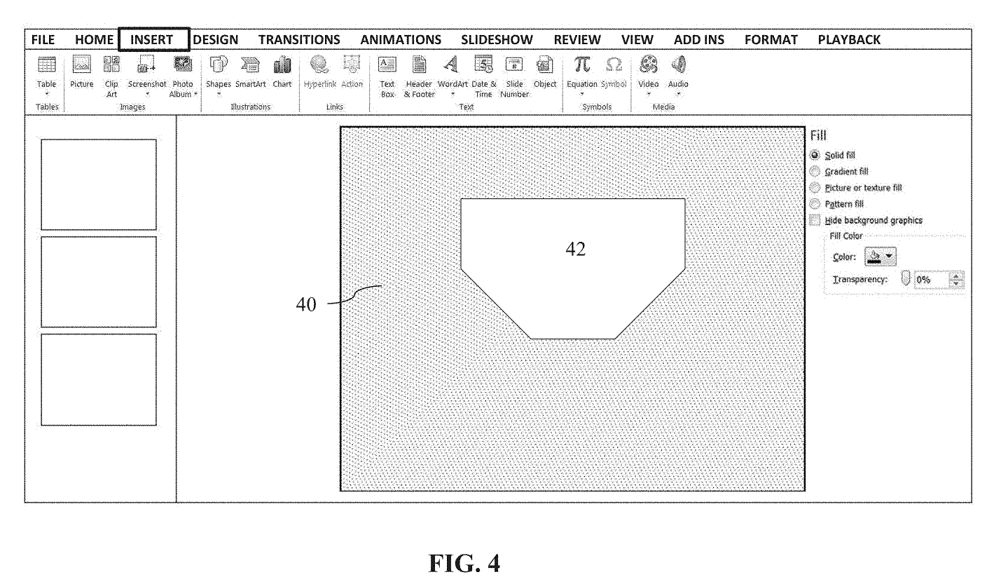

FIG. 4 shows a screenshot from the multimedia presentation software application of a hologram slide 40. To make a hologram slide 40, click File, Insert, Shapes, Rectangles, choose this shape 42 as shown. The shape 42 has 6 sides.

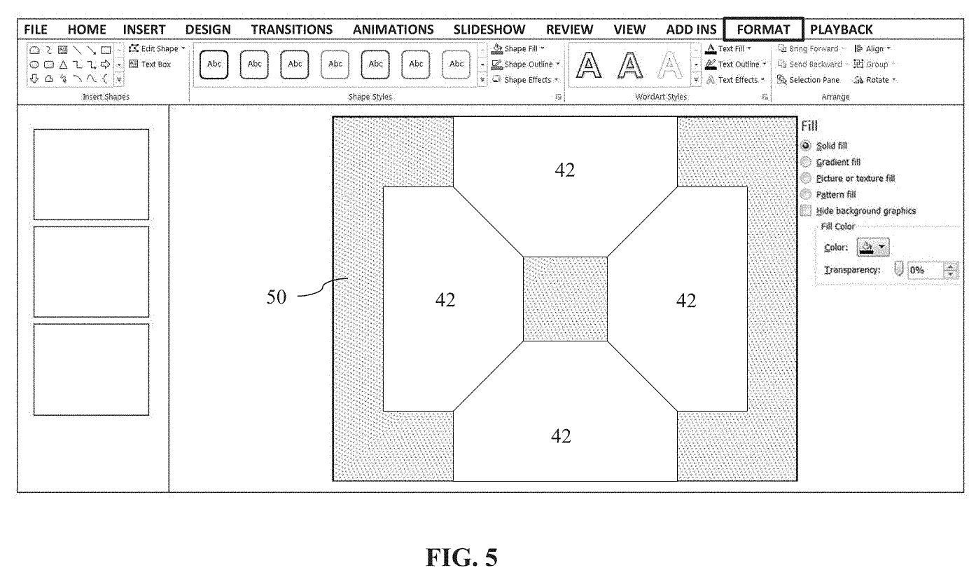

FIG. 5 shows a representative screenshot from a software application that creates multimedia presentations in which the hologram slide 40 is copied 4 times and rotated in an equal pattern to create a quadraplex image 50 with 4 shaped portions 42.

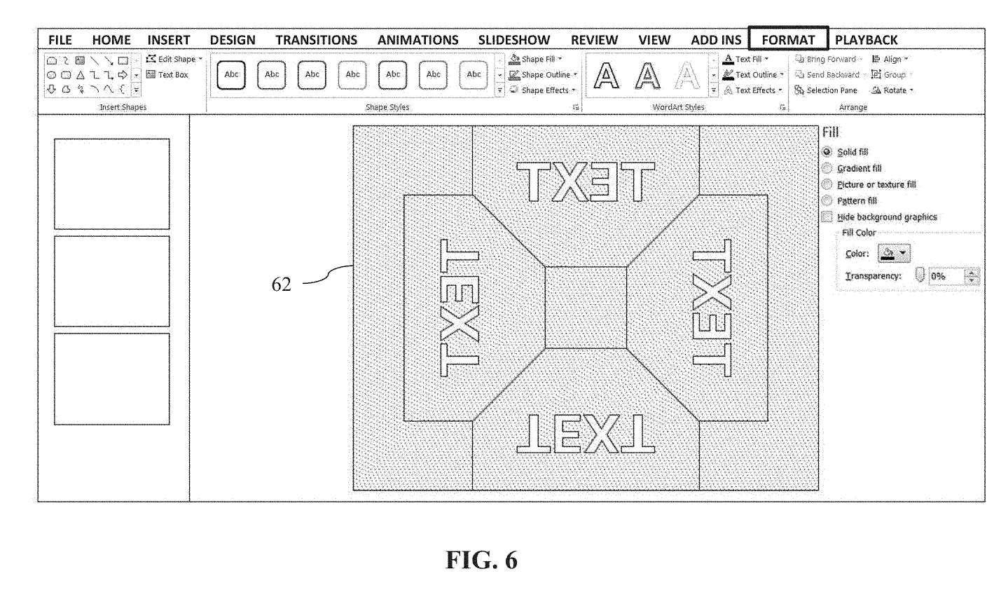

FIG. 6 shows a representative screenshot from a software application that creates multimedia presentations in which an image is inserted into each of the 4 portions of the quadraplex image 50. By clicking on the 4 shapes 42 simultaneously, one can insert a picture or image 62. In PowerPoint™, one can insert a file with the following extensions:
Windows Enhanced Metafile
Windows Metafile
JPEG File Interchange Format
Portable Network Graphics
Windows Bitmap
Graphics Interchange Format
Compressed Windows Enhanced Metafile
Compressed Windows Metafile
Compressed Macintosh PICT
Tag Image File Format
Encapsulated PostScript
Macintosh PICT
WordPerfect Graphics
Portable Document Format
   Upon inserting the picture 62, it will automatically propagate the 4 shapes 42. If inserting a “text” file or text graphics, the picture 62 will have to be flipped or reversed or rotated 180 degrees.

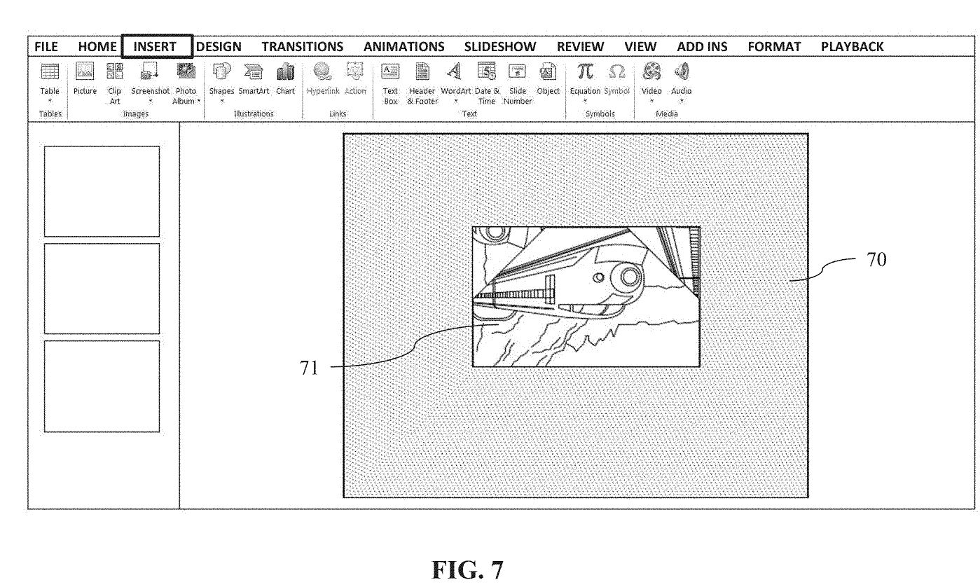

FIG. 7 shows a screenshot from the multimedia presentation software application of a hologram video slide 70.

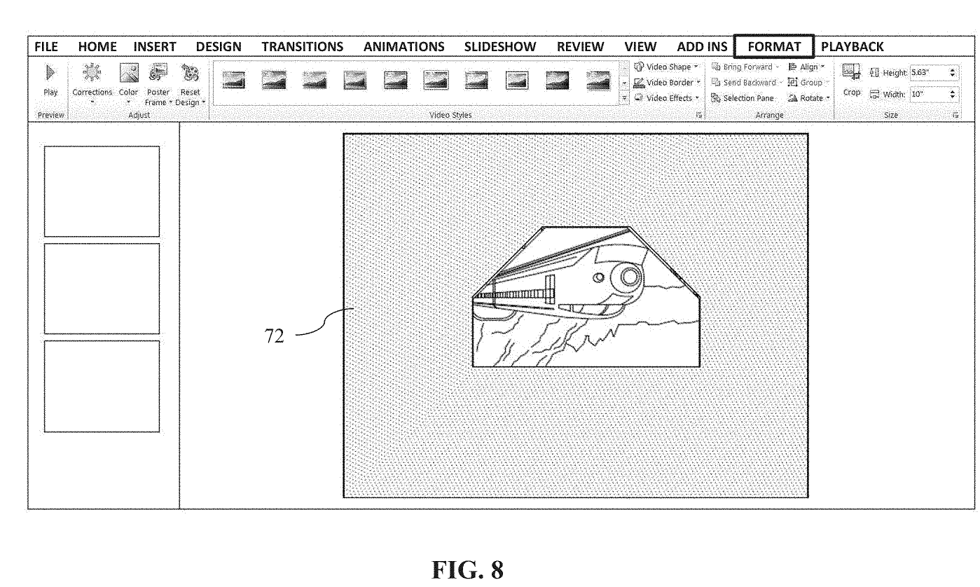

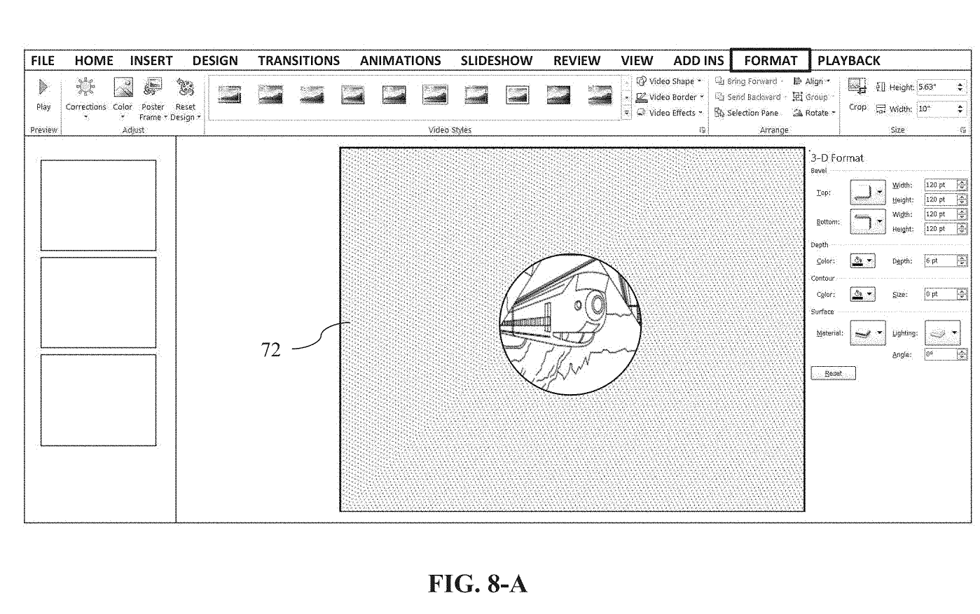

FIG. 8 shows a screenshot from the multimedia presentation software application of a hologram video slide 70 that has been shaped. FIG. 8-A shows a screenshot from the multimedia presentation software application of a hologram video slide 70 in the shape of a sphere.

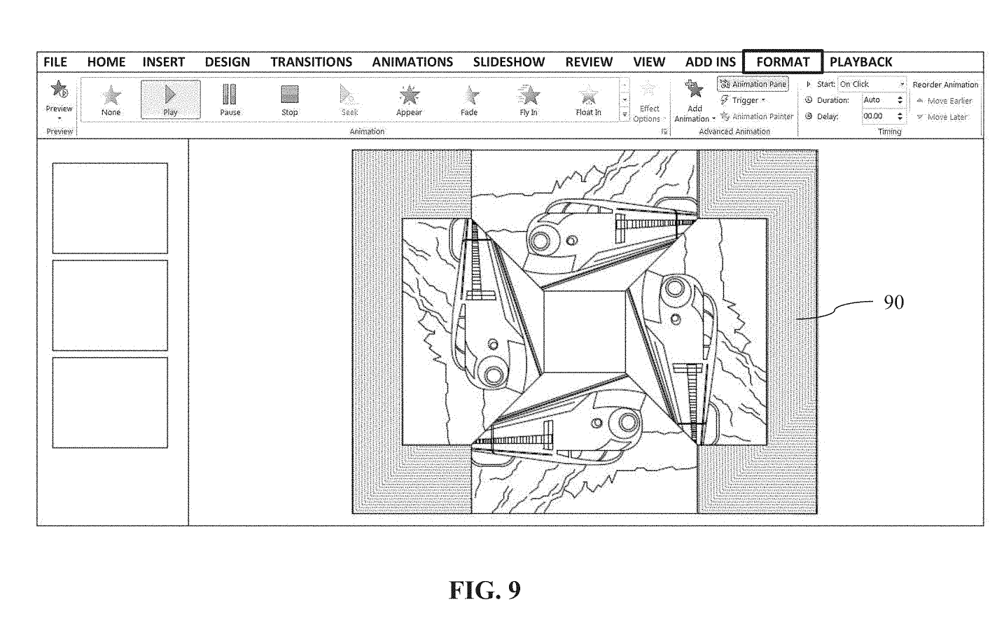

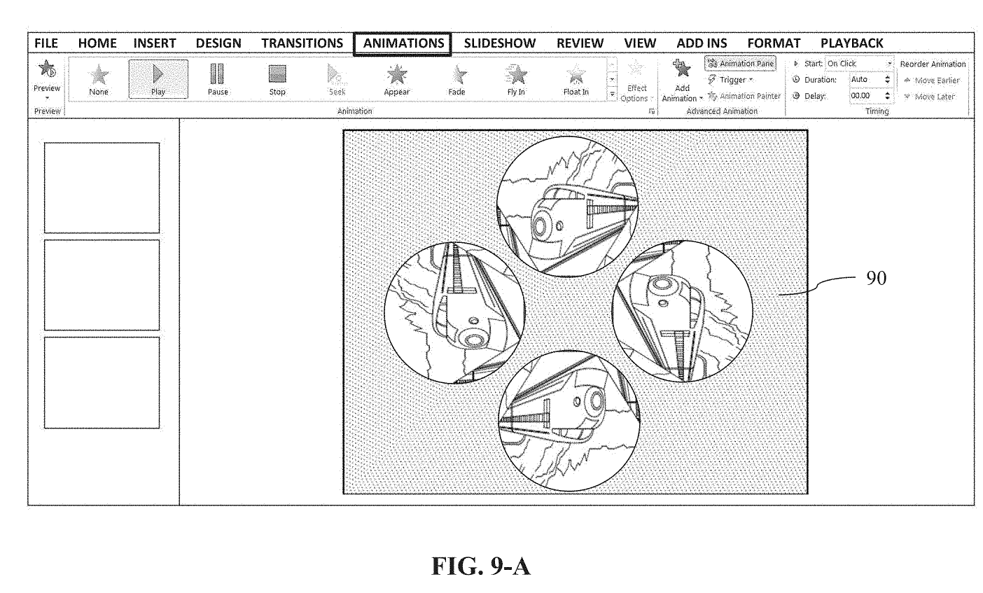

FIG. 9 shows a representative screenshot from a software application that creates multimedia presentations in which the shaped hologram video slide 72 is copied 4 times and rotated to create a quadraplex video image 90. FIG. 9-B shows a representative screenshot from a software application that creates multimedia presentations in which the hologram video slide 72 in the shape of a sphere is copied 4 times and rotated to create a quadraplex video image 90.

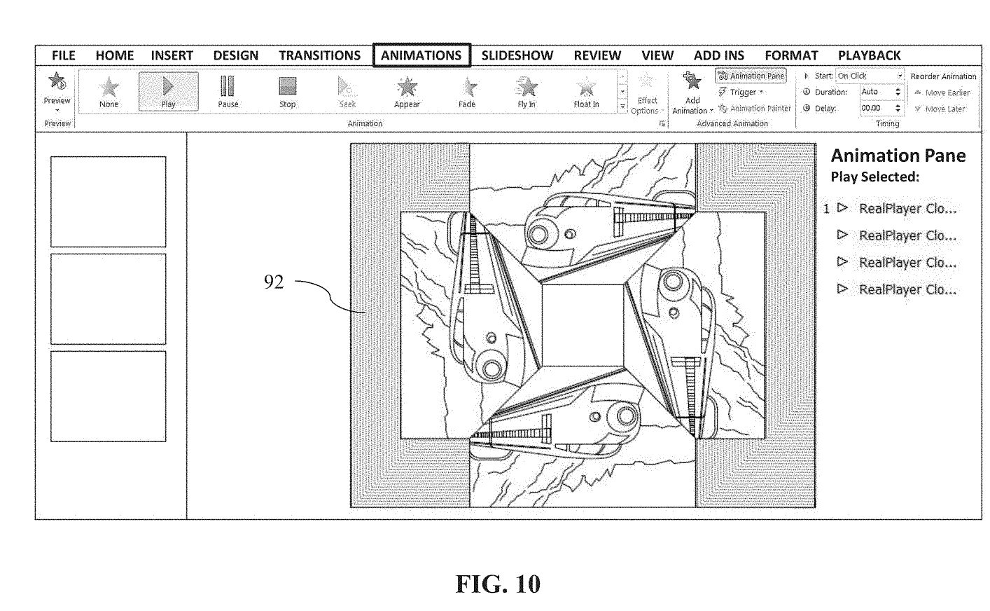

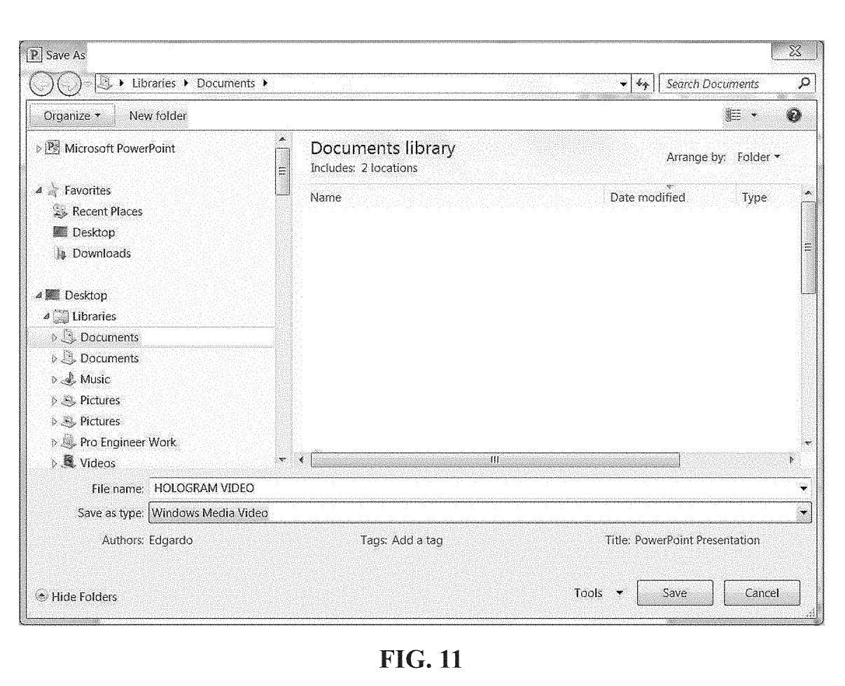

FIG. 10 shows a representative screenshot from a software application that creates multimedia presentations in which the quadraplex video image 90 is viewed through the animation control pane 92. FIG. 11 is a representative screenshot from a software application that creates multimedia presentations in which the animated quadraplex video image 92 can be saved as a WMV or other video/movie file extension.

To create a hologram video, click File, Insert, Video Menu, then browse and choose Video 71 on PC or Mac or in the Cloud. Insert the movie file with the following file extensions available for use in PowerPoint™:
Windows Media File (asf)
Windows Video File (avi)
QuickTime Movie File
MP4 Video
Movie File (mpeg)
MPEG-2TS Video
Windows Media Video File (wmv)
Adobe Flash Media
MP4
   Then, click on File, Video Tools, Format, Video Shape, Rectangles, choose the shape 72 as shown. Click on the video 72 and copy it 4 times, rotate the 4 images 71 in 4 shapes 72 into an equal pattern 90 as shown. Then, click the 4 videos 70 at the same time, click Animation, click Play. Click on the Animation Pane to edit how the 4 videos are played, then click Play or Preview. The 4 videos 70 will run at the same time. Once can also click each video 70, and edit the Play Video effect option like sound, timing options, etc. Finally, save the file as a Windows Media Video file extension (*.wmv) or MPEG-4 video file.

Another way to create a hologram video relies upon the use of any common video editing app that runs on a mobile device. As an example, InShot™ is a video editor that includes the following features:
Video Trim & Cut—Trim video, Cut/Delete middle part of a video
Tool for Instagram—Blur border for photo and video; Make it square ready for Instagram; Colored border to make it square ready; Move video/photo inside the square.
Music—Add your own music to video, like mp3 files and other format; Easy to sync sound and video, with timeline features; Volume control for both original video sound and mp3 songs.
Text & Emoji—Add text on video and photo; Add emoji on photo; With timeline features, easy to sync text and emoji with video.
Filters—Lots of Photo filters; Video filters
Edit—Rotate, Flip photo or video; Photo Collage
Share—1080P video supported; Customized video output resolution; Share to social apps, like Facebook, Twitter, Instagram, WhatsApp, etc.
   https://itunes.apple.com/us/app/video-editor-no-crop-music-cut/id997362197?mt=8

In a first step, an image or video is selected and inserted into the viewing window.

The image or video can be rotated 180°.

The image or video should be flipped to give the mirror opposite of the non-rotated version.

Camera MX is another popular, complete solution camera app that can be used to create and edit photos and videos. Features include:
Simple user interface—The intuitive user interface in Camera MX makes recording videos and photos quicker and easier.
Intelligent image processing for high photo quality and visibly sharper results.
Extensive photo and video editing effects including HDR, Lomo, flip, kaleidoscope, automatic optimization, overlays and textures; optimization options including brightness adjustment, photo and video rotation, contrast, saturation, color temperature; cut and trim photos and videos, as well as adjust their size and resolution.
Live Shot to create moving photos or share animated photos with friends.
Shoot The Past feature lets you rewind within Live Shot and capture what happened before the actual photo; Capture difficult to photograph subjects, for instance laughing babies, lightning, moving animals.
Scene modes including selfie, night, sunset, snow, landscape, etc.
Supports 16:9 aspect ratios.
Clearly arranged media manager to keep track of photos and videos; Use multi-selection to quickly delete, move or copy several files at once; Manual sorting of files.
Tablet compatible—can even be used without a camera.
Print photos; Select photos and send as postcards.
   https://play.google.com/store/apps/details?id=com.magix.camera_mx&hl=en

To make a holographic video of the present invention one can download an app such as CameraMX™ or similar and follow these steps:

Turn on the camera or other mobile device such as tablet, pad, etc., and lay the device flat so that the screen is on top.

Reverse the Camera icon to front-facing or “selfie” mode. This allows one to see themself in the camera screen.

Select Effects, click Kaleidoscope options and set it to 4 camera input.

Place a 45° reflecting mirror on top of the device covering the front-facing camera lens.

Place a 4 sided triangular holographic reflecting inverted pyramid on top of the device screen. This should result in the production of a holographic video which can be viewed live, performed for an audience, or recorded.

Thus, it is possible to provide a virtual reality/augmented reality experience with a hologram and get an immersive sensory, i.e., auditory/visual experience, by downloading social media mobile applications including but not limited to “Skype”™, “FaceTime”™, “Viber”™, or voice recognition Interactive Search Engines like “Ok Google”™ and “Siri”™, etc.

To make a spherical holographic video, FIG. 8-A shows to insert video, format, video shape, then select circle instead of triangle, select 3D format, select change bevel, and select change material. FIG. 9-A shows how the slide can be copied 4 times and rotated as shown, click 4 videos and click play to play at the same time. The file can also be saved as *.wmv or other video or movie file.

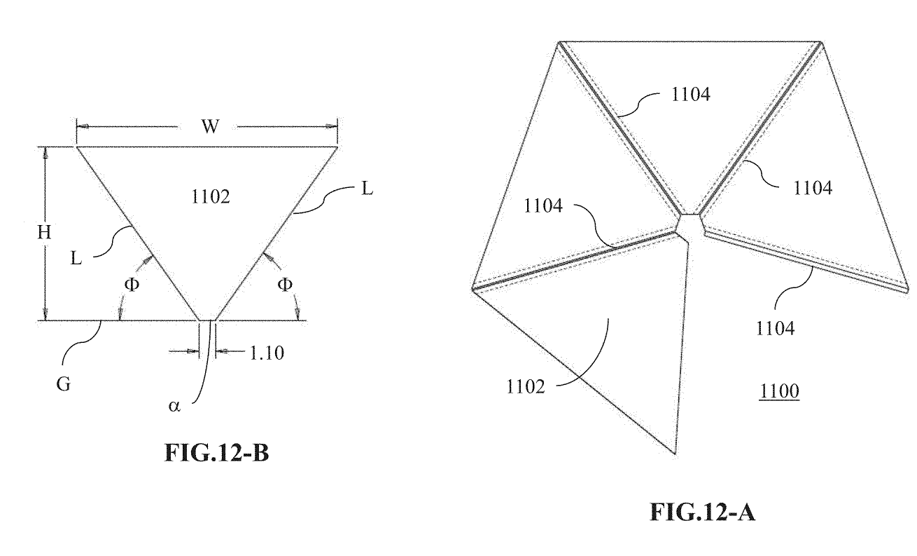

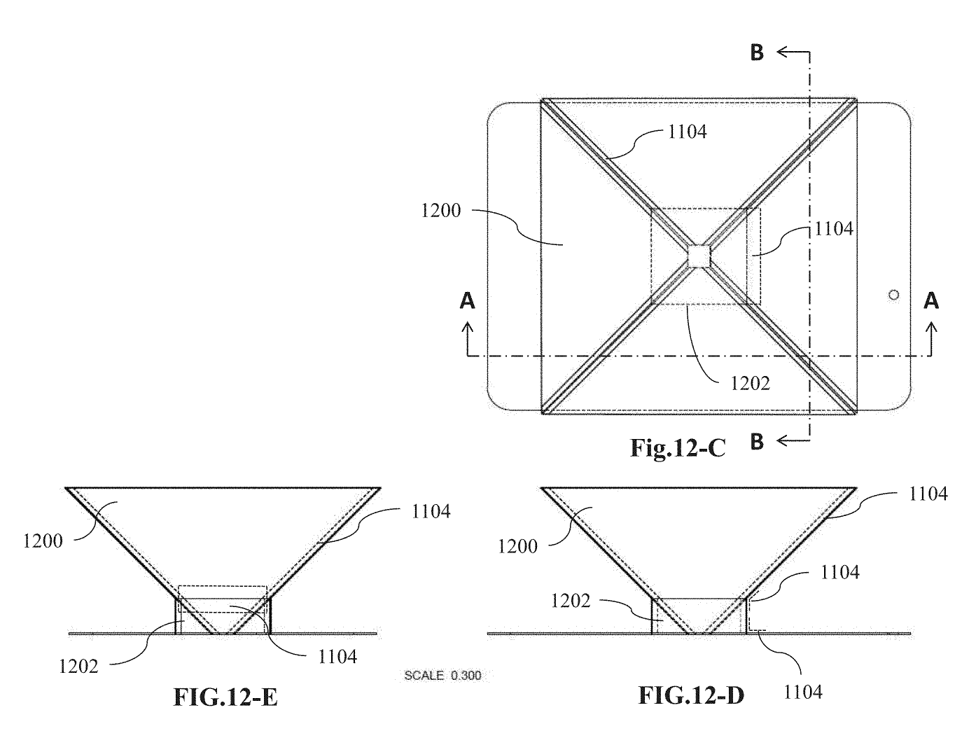

FIG. 12-A is a representative top view of an unfolded 4× hologram triangle projector pyramid 1100 of the present invention. FIG. 12-B is a representative side view of one (1) of the four (4) equivalent-shaped triangles sides 1102 of the 4× hologram triangle projector pyramid 1100 of the present invention.

When laying flat, the projector 1100 consists of 4 individual triangular sections 1102 coupled together as shown. The projector 1100 can be assembled using 4 separate triangular sections 1102 or a single piece of clear, transparent acrylic, glass or similar material. Sections 102 can be made of other high strength, thin clear, highly reflective material with a glossy surface. Plexiglass is good, and other scratch-proof materials or coatings are also considered within the scope of the present invention.

In geometry, an isosceles triangle is a triangle that has at least two sides of equal length. The equilateral triangle in which all three sides are equal in length, is a type of isosceles triangle. https://en.wikipedia.org/wiki/Isosceles_triangle

In the embodiment shown, sections 102 each have the size ratio of 17.38 on the wide side W, 1.10 at the apex α and height H 11.50. There is a 54.7° angle formed between each leg of the triangle L and the horizontal G. The legs L of each section 1102 can be joined with clear adhesive tape 1104.

FIG. 12-C is a representative top view of an assembled 4× hologram triangle projector inverted pyramid 1200 of the present invention. FIG. 12-D is a representative side view of an assembled 4× hologram triangle projector inverted pyramid 1200 of the present invention taken at section A-A. FIG. 12-E is a representative front view of an assembled 4× hologram triangle projector inverted pyramid 1200 of the present invention taken at section B-B.

When assembled, the 4× hologram triangle projector inverted pyramid 1200 is in the shape of an inverted pyramid. A small stand 1202 made of rectangular sections of plastic or acrylic supports the projector pyramid 1200 in an inverted position.

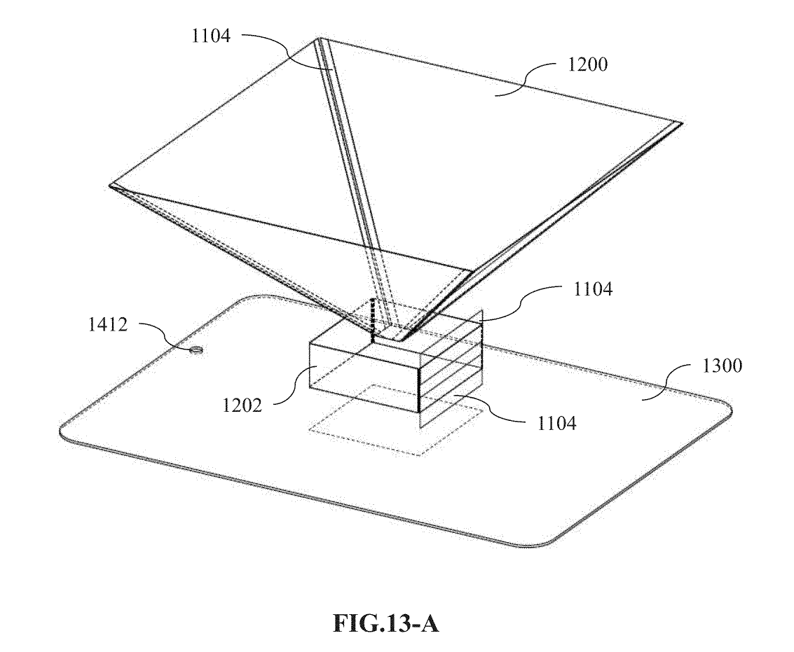

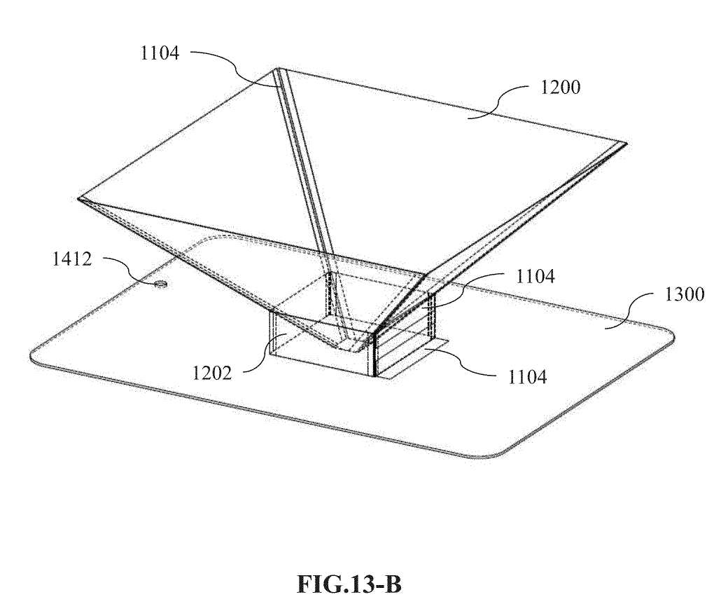

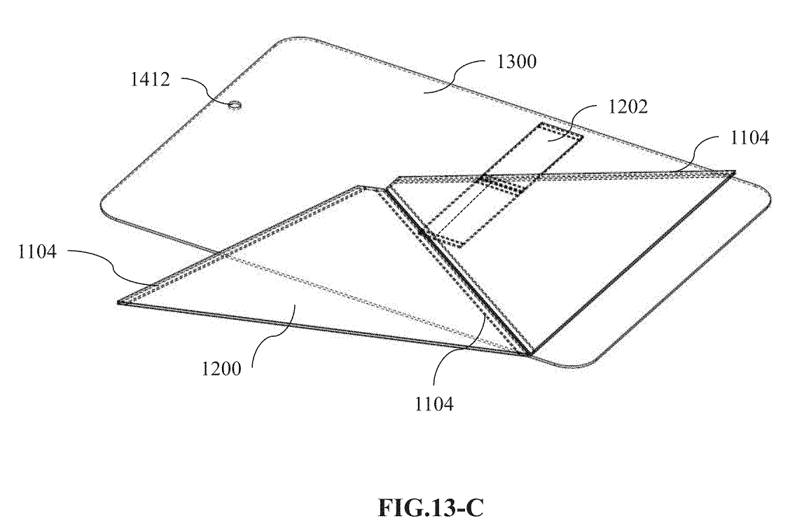

FIG. 13-A is a representative orthogonal view of an assembled 4× hologram triangle projector inverted pyramid 1200 of the present invention in alignment with a flat screen holographic multimedia presentation player 1300 of the present invention. FIG. 13-B is a representative orthogonal view of an assembled 4× hologram triangle projector inverted pyramid 1200 of the present invention mounted onto a flat screen holographic multimedia presentation player 1300 of the present invention.

FIG. 13-C is a representative orthogonal view of a folded 4× hologram triangle projector pyramid 1200 of the present invention mounted onto a flat screen holographic multimedia presentation player 1300 of the present invention. It will be understood that for storing, transporting or otherwise, it is possible to fold the 4× hologram triangle projector pyramid 1200 of the present invention to save space and reduce the physical space requirement of the device.

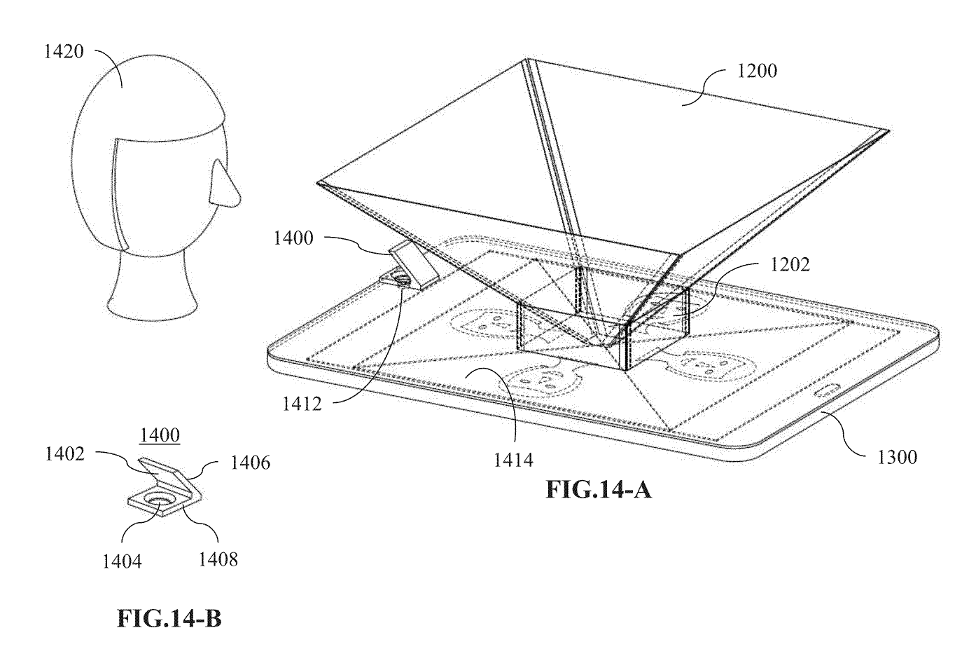

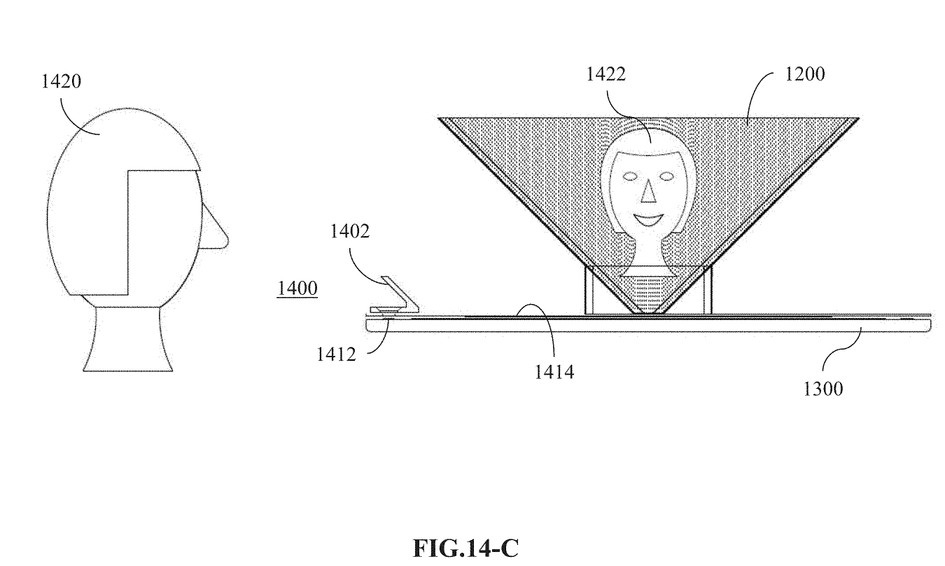

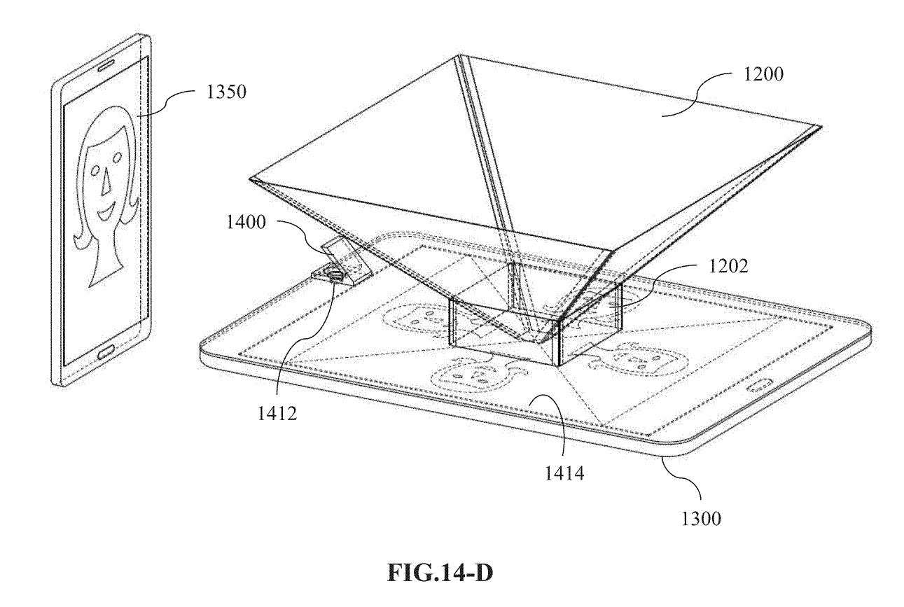

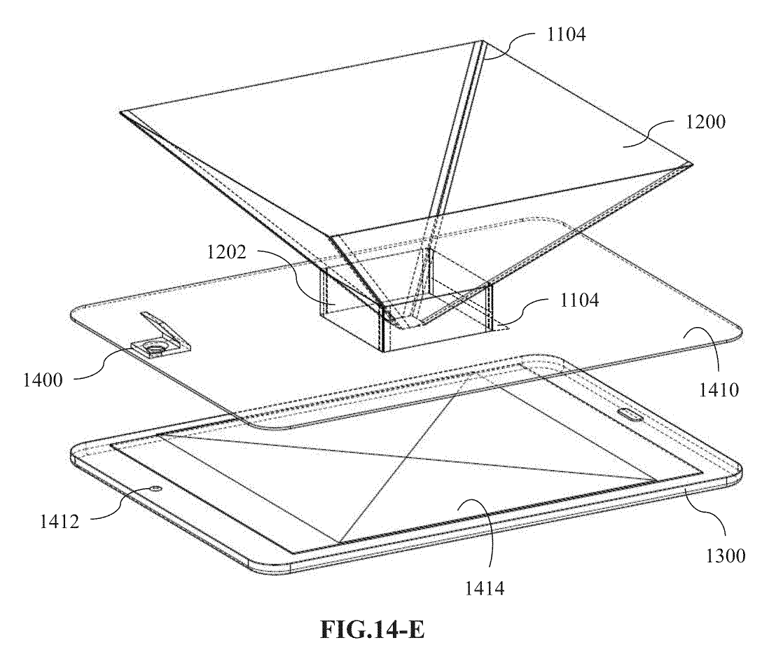

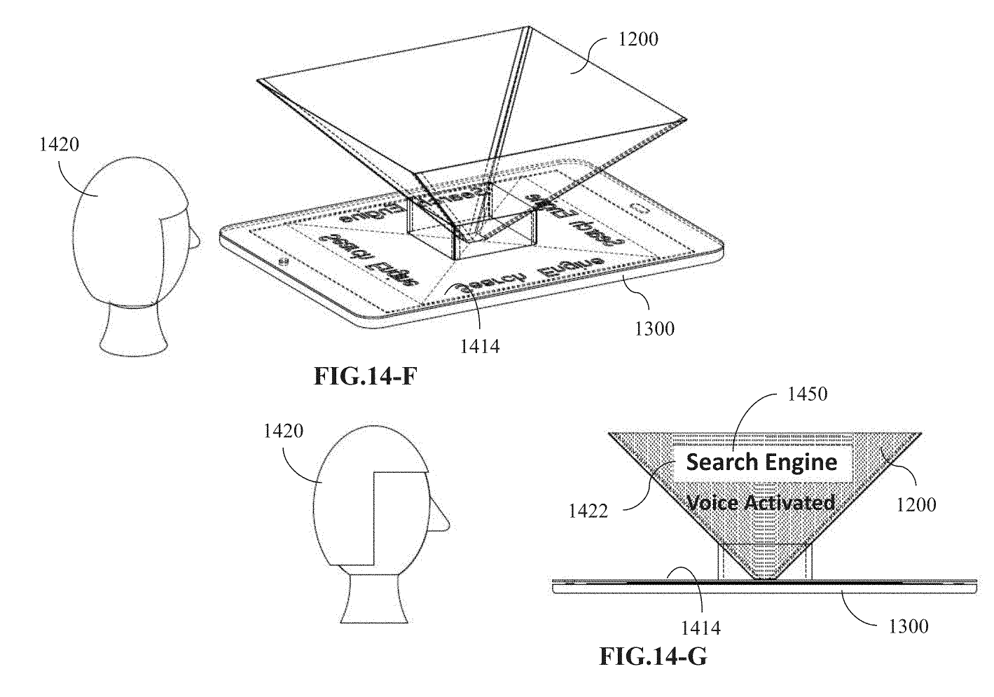

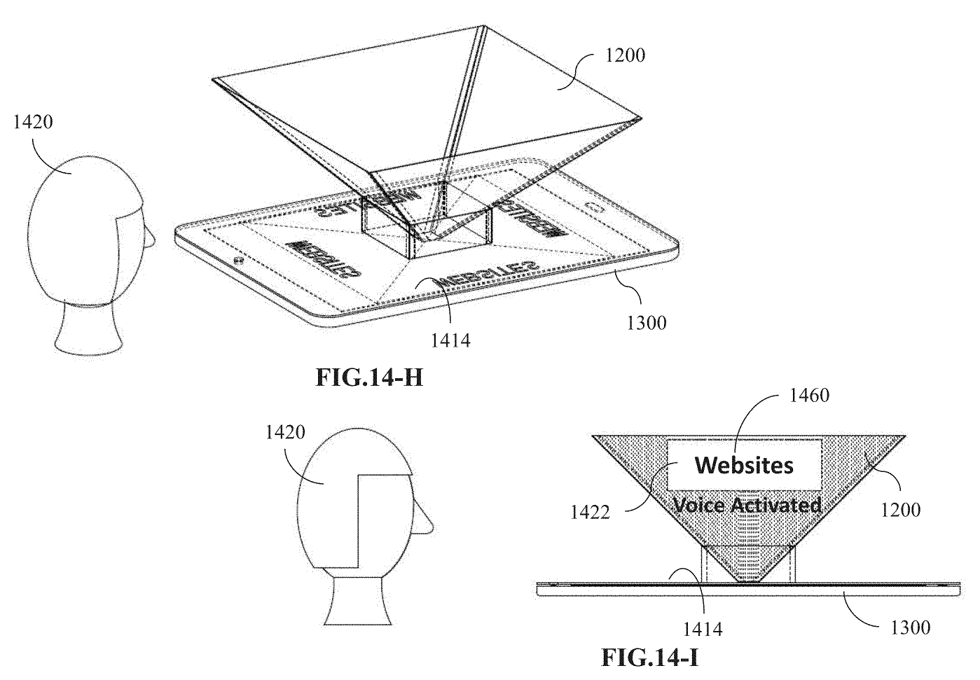

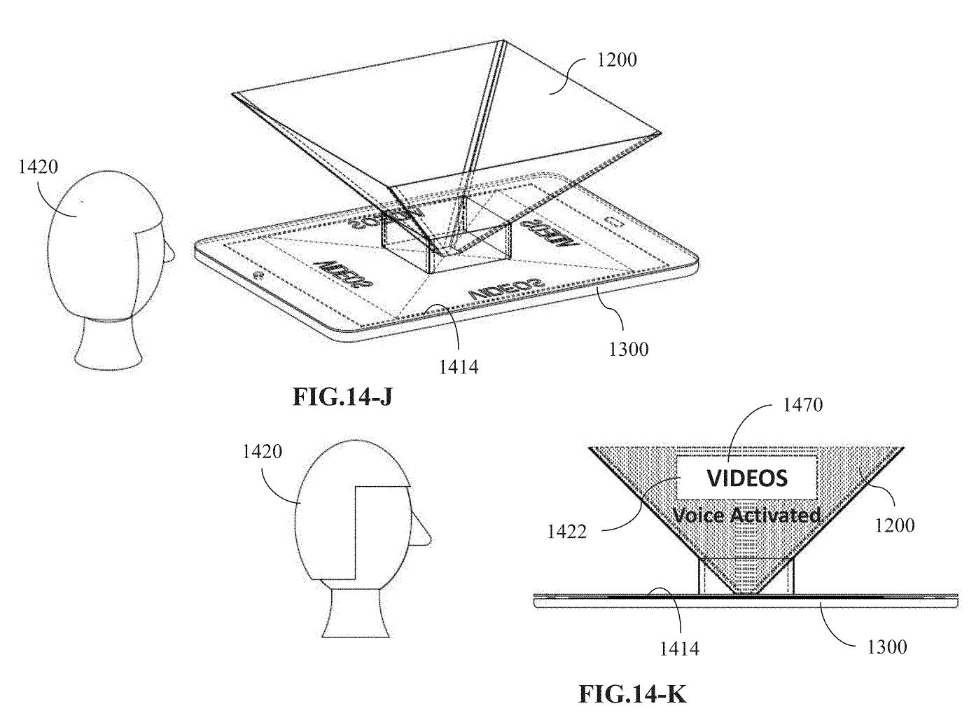

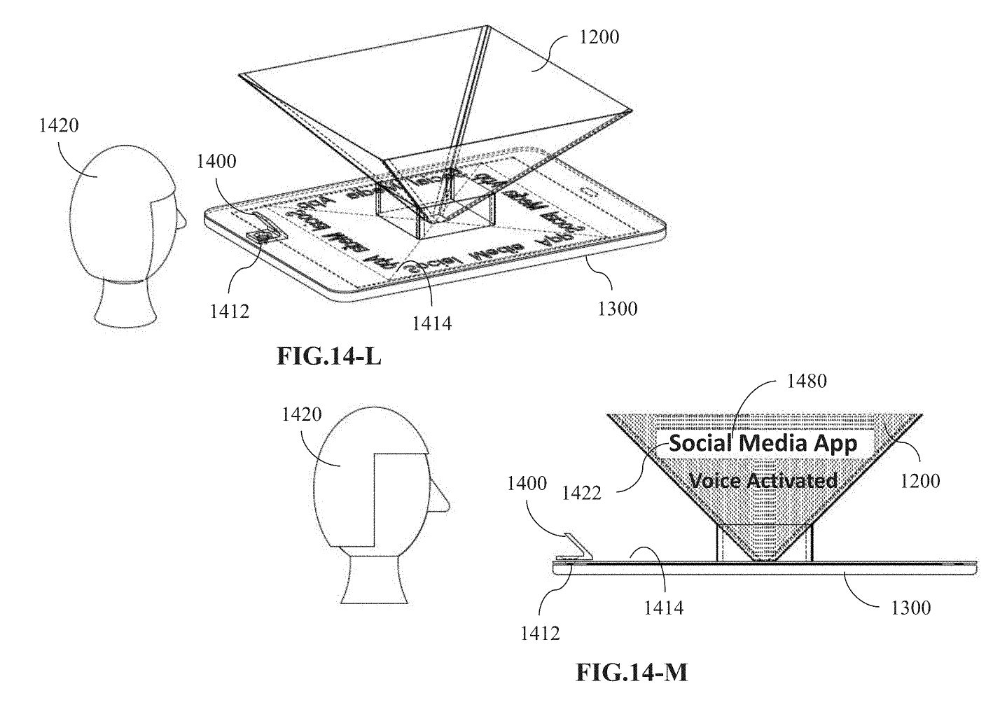

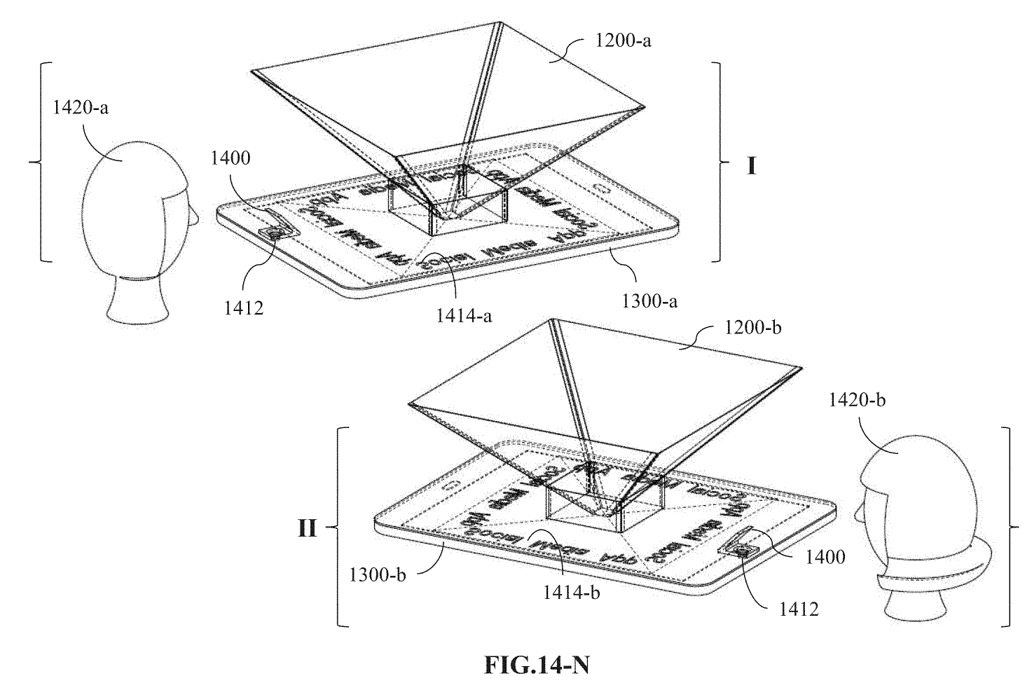

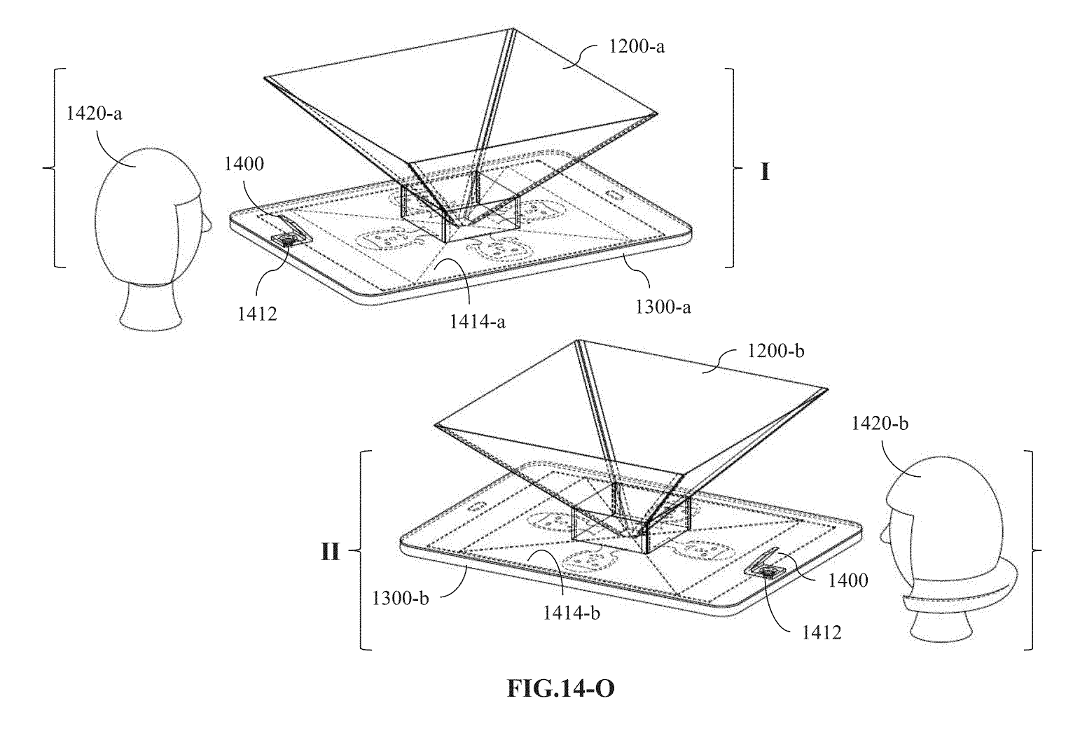

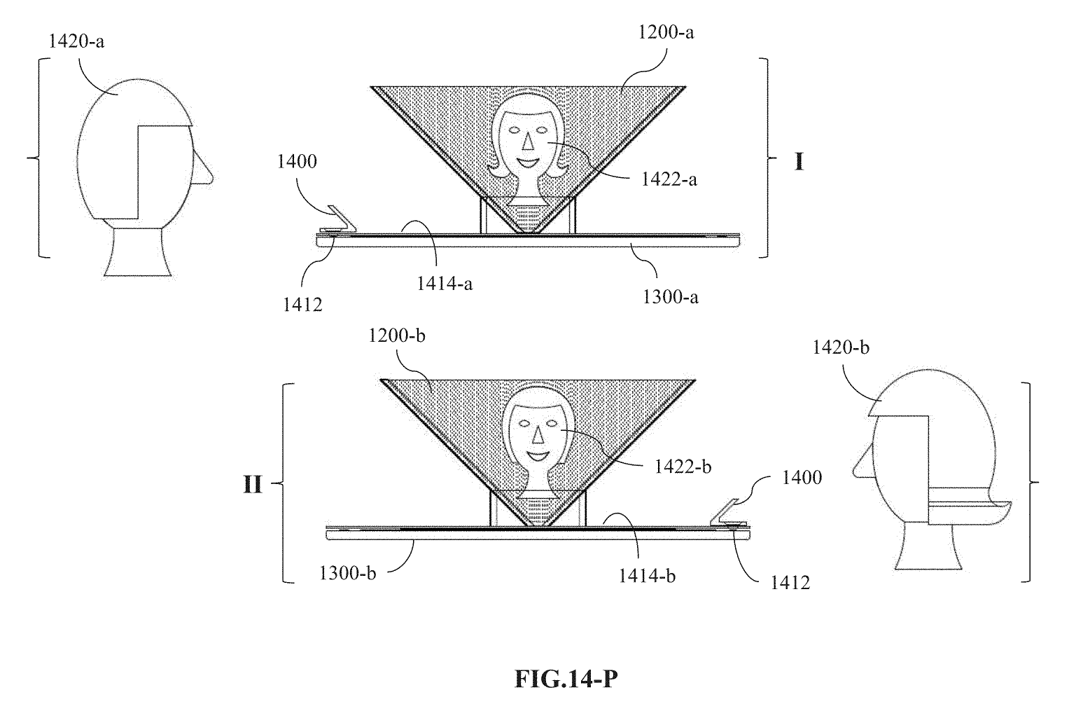

FIG. 14-A is a representative orthogonal view of a method of use of the 4× hologram triangle projector inverted pyramid 1200 of the present invention and a flat screen holographic multimedia presentation player 1300 of the present invention. FIG. 14-B is a detail view of a 45° selfie mirror 1400 used with a flat screen holographic multimedia presentation player 1300 of the present invention. FIG. 14-C is a side view of a method of use of the 4× hologram triangle projector inverted pyramid 1200 of the present invention and a flat screen holographic multimedia presentation player 1300 of the present invention.

The 45° selfie mirror 1400 consists essentially of a small mirror 1402 held in a support 1406 with a hole 1404 in a base portion 1408. When the device 1400 is placed over the self-facing camera lens 1412, the image of an object 1420 such as a person located in front of the selfie mirror 1400 will be reflected from the mirror 1402 through the hole 1404 in the base 1408 into the camera lens 1412. When the image is processed by the flat screen holographic multimedia presentation player 1300 the quadraplex image 1414 is projected from the screen of the flat screen holographic multimedia presentation player 1300 to the inverted

As shown, an object 1420 in front of the 45° reflecting mirror 1400 will create a holographic image 1422 that is transmitted through the front-facing camera lens 1412 and is projected from the screen 1414 of the device 1300 into the 4× hologram triangle projector inverted pyramid 1200.

FIG. 14-D is another representative view of a method of use of the 4× hologram triangle projector pyramid 1200 of the present invention with a flat screen holographic multimedia presentation player 1300 of the present invention. It will be understood that by placing a second multimedia presentation player 1350 in front of the 45° reflecting mirror 1400, then an image, a video, a Skype session or other live video broadcast emanating from the second player 1350 can be converted into a holographic multimedia video and displayed or performed via the 4× hologram triangle projector inverted pyramid 1200 of the present invention. It will also be understood that the screen on the second player 1350 can be created by sharing a screen from another mobile device, etc.

FIG. 14-E is a representative view of a method of use of a privacy screen 1410 disposed between the 4× hologram triangle projector pyramid 1200 of the present invention and the flat screen holographic multimedia presentation player 1300 of the present invention. In this embodiment, a privacy screen 1410 is useful for blocking the view of the image projected from the screen 1414 of the device 1300. This prevents light from the projecting screen 1414 from distracting the attention of the viewing audience from the holographic image or video presentation.

FIGS. 14-F and 14-G are orthogonal and side views, respectively, of a method of use of the 4× hologram triangle projector inverted pyramid 1200 of the present invention and a flat screen holographic multimedia presentation player 1300 of the present invention for performing voice activated searches on the internet using a search engine 1450 as desired. A user 1420 can activate a search engine 1450 and perform a search for any desired data such as an item, event, person or other theme, by using her voice. The flat panel display 1300 projects the quadraplex image 1414 of the search engine 1450 search result to the projector 1200. The control panel as well as search results from the search engine 1450 are displayed in the inverted pyramid holographic projector 1200.

FIGS. 14-H and 14-I are orthogonal and side views, respectively, of a method of use of the 4× hologram triangle projector inverted pyramid 1200 of the present invention and a flat screen holographic multimedia presentation player 1300 of the present invention for voice activated accessing of websites 1460 on the internet as desired. A user 1420 can access websites 1460 and browse, shop, do online banking or other process using an online web portal, etc., by using her voice. The flat panel display 1300 projects the quadraplex image 1414 of the website 1460 to the projector 1200. The website 1460 is displayed in the inverted pyramid holographic projector 1200.

FIGS. 14-J and 14-K are orthogonal and side views, respectively, of a method of use of the 4× hologram triangle projector inverted pyramid 1200 of the present invention and a flat screen holographic multimedia presentation player 1300 of the present invention for voice activated video 1470 control as desired. A user 1420 can access video content 1470 by using her voice. The flat panel display 1300 accesses the video content 1470 such as via Netflix™, iTunes™, etc., projects the quadraplex image 1414 of the video 1470 to the projector 1200. The video 1470 is displayed in the inverted pyramid holographic projector 1200.

FIGS. 14-L and 14-M are orthogonal and side views, respectively, of a method of use of the 4× hologram triangle projector inverted pyramid 1200 of the present invention and a flat screen holographic multimedia presentation player 1300 of the present invention for voice activated accessing of social media apps 1480 as desired. A user 1420 can access social media apps 1480 by using her voice. The flat panel display 1300 has the social media app 1480 installed on it, and projects the quadraplex image 1414 of the social media app 1480 to the projector 1200. The social media app 1480 is displayed in the inverted pyramid holographic projector 1200.

FIG. 14-N is an orthogonal view of a method of use of the 4× hologram triangle projector inverted pyramid 1200 of the present invention and a flat screen holographic multimedia presentation player 1300 of the present invention for two (2) or more individuals or entities to interact as desired via social media apps. Such social media apps include but are not limited to“Skype”, “Facetime”, “Viber”, “Facebook”, etc.

As shown in part I, a first user 1420-a can access social media apps 1480 by using her voice. The image of the first user 1420-a is captured via 45° reflecting mirror 1400 and through the self-facing camera lens 1412 and processed by the first flat screen holographic multimedia presentation player 1300-a. The flat panel display 1300-a has the social media app 1480 installed on it, and projects the quadraplex image 1414-a of the social media app 1480 to the projector 1200-a. The social media app 1480 is displayed in the inverted pyramid holographic projector 1200-a.

As shown in part II, a second user 1420-b can access social media apps 1480 by using her voice. The image of the first user 1420-b is captured via 45° reflecting mirror 1400 and through the self-facing camera lens 1412 and processed by the second flat screen holographic multimedia presentation player 1300-b. The flat panel display 1300-b has the social media app 1480 installed on it, and projects the quadraplex image 1414-b of the social media app 1480 to the projector 1200-b. The social media app 1480 is displayed in the inverted pyramid holographic projector 1200-b.

Thus, two (2) or more users can talk to each other and view each other such as currently possible only via video chat such as Skype™, Facetime™, etc. The present invention is a form of holographic video chat. The present invention is also a alternative to “Skyping” or the “Webex Cisco” or the OK Google or Siri voice activated apps. Using a holographic projector of the present invention instead of viewing it on a laptop screen monitor/mobile screen device/screen tablet, one can view everything on a hologram projector giving the user a different, immersive 3D augmented reality feel, which is better than using a Google™ or other V.R. gear.

FIGS. 14-O and 14-P are orthogonal and side views, respectively, of a method of use of the 4× hologram triangle projector inverted pyramid 1200 of the present invention and a flat screen holographic multimedia presentation player 1300 of the present invention for two (2) or more individuals or entities to interact as desired via video chat apps.

As shown in part I, a first user 1420-a can activate a video chat. The image of the first user 1420-a is captured via selfie 45° reflecting mirror 1400 and through the self-facing camera lens 1412 and processed by the first flat screen holographic multimedia presentation player 1300-a. The flat panel display 1300-a has the video chat app installed on it, and projects the quadraplex image 1414-a of the video chat app to the projector 1200-a. The video chat app is displayed in the inverted pyramid holographic projector 1200-a.

As shown in part II, a second user 1420-b can activate a video chat app. The image of the first user 1420-b is captured via selfie 45° reflecting mirror 1400 and through the self-facing camera lens 1412 and processed by the second flat screen holographic multimedia presentation player 1300-b. The flat panel display 1300-b has the video chat app installed on it, and projects the quadraplex image 1414-b of the video chat app to the projector 1200-b. The video chat app is displayed in the inverted pyramid holographic projector 1200-b.

Thus, the projected holographic image 1422-a of the second user 1420-b can be projected by the first inverted holographic projector 1200-a for viewing by the first user 1420-a, while the projected holographic image 1422-b of the first user 1420-a can be projected by the second inverted holographic projector 1200-b for viewing by the second user 1420-b. in this way, a first user 1420-a and a second user 1420-b can participate in a video chat with each user viewing the other user as a moving holographic video image.

Another feature of the present invention is the ability to create a spherical “video”. This type of spherical holographic video is also known as a “Holo space”™ holographic multimedia presentation. The spherical holographic video can be used for presentations, performance of video and other multimedia presentations for entertainment and education, meetings between 2 or more persons, for participation with social media platforms such as FaceTime, Viber, Twitter, LinkedIn, etc., for downloading content and sharing content such as in streaming or stored files, etc.

The hologram projector 1200 offers an alternative to viewing “websites”, “videos”, “search engines”, “social media apps”, etc by creating an augmented reality feel like virtual reality. In other words, the hologram projector system of the present invention creates a new way of viewing things.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1. A folding holographic projector which can be stored and transported in a flattened, unfolded configuration and which can be used to project holographic object and video images when folded into an inverted pyramid configuration, the folding holographic projector comprising:
Four equal size, isosceles triangular shaped sections of semi-rigid, transparent material, the isosceles triangular shaped portions each having 2 sides of equal length; and
Four live hinges formed of transparent flexible material, the four live hinges arranged alternatingly between the triangular shaped portions, wherein each of the four live hinges couple together the equal length sides of adjacent triangular shaped sections.

2. The folding holographic projector of claim 1 wherein each of the corners of the triangular shaped sections that are formed by the conjoining of the 2 legs of equal length are removed such that each of the triangular shaped sections is in the shape of a truncated triangle and when the folding holographic projector is folded for use, the apex of the pyramid is open.

3. The folding holographic projector of claim 1, further having a stand, the stand formed out of:
Four rectangular sections of semi-rigid transparent material, each of the rectangular sections having 2 long ends and 2 short ends wherein the short ends of each of the rectangular sections are adjacent each other; and
Four live stand hinges formed of transparent flexible material, the four live stand hinges arranged alternatively between the short ends of the rectangular sections, wherein each of the four live stand hinges couple together the short sides of adjacent rectangular sections.

4. The folding holographic projector of claim 3 wherein one of the long sides of one of the four rectangular sections is coupled with a fifth live stand hinge to one of the four triangular sections, the fifth live stand hinge made of flexible, transparent material, such that when the projector is folded for use the four rectangular sections form a square box which supports the four triangular sections folded in the shape of a pyramid.

5. A method of creating a folding, holographic production projector, the method comprising the following steps:
Obtaining four isosceles triangle shaped sections of semi-rigid, transparent material;
Coupling the four isosceles triangle shaped sections together with a portion of flexible, transparent adhesive tape;
Eliminating the apex corner from each of the four isosceles triangle shaped sections in order to form a flattened end tip on each of the four isosceles triangle shaped sections;
Folding the assembly of four isosceles triangle shaped sections into the shape of an inverted and truncated pyramid.

6. The method of claim 6 further comprising the following steps:
Obtaining four rectangular sections of semi-rigid transparent material, each of the rectangular sections having 2 long ends and 2 short ends;
Arranging the four rectangular sections such that the short ends of each of the rectangular sections are adjacent each other;
Coupling the short ends of the four rectangular sections together using flexible, transparent adhesive tape;
Coupling the long end of one of the four rectangular sections to the flattened end tip of one of the four isosceles triangle shaped sections using flexible, transparent adhesive tape; and
Folding the four isosceles triangle shaped sections into the shape of an inverted pyramid with the four rectangular sections forming a square box which supports the four triangle shaped sections in the shape of a pyramid.

7. A method of creating and giving a holographic multimedia presentation which can be displayed using a flat panel screen and an pyramid shaped holographic image projector, the method comprising the following steps:
\Obtaining a picture editor software application;
Creating a hologram slide by selecting the desired size parameters;
Selecting black as the color of the hologram slide;
Selecting a desired shape for the hologram slide from either a database of different base forms or creating the desired shape from a sizing dialog box.
Copying the hologram slide with the desired shape to create four identical shaped hologram slides;
Turning, inverting and assembling the four hologram slides into a single, quadraplex holographic slide;
Inserting a picture image into the shaped hologram slide such that the picture image populates the quadraplex holographic slide; and
Projecting the quadraplex holographic slide from the flat panel screen using an inverted pyramid holographic projector.

8. The method of claim 7 in which the multimedia presentation includes holographic video image, the method comprising the following steps:
Inserting a video file into the shaped hologram slide such that the video image populates the quadraplex holographic slide.

9. The method of claim 8 in which the video file used for the holographic video image is a live video stream.

10. The method of claim 8 in which the multimedia presentation is distributed to viewers via social media.

11. The method of claim 8 in which the flat panel screen is the screen of a handheld mobile device.

12. The method of claim 11 in which the handheld mobile device is one selected from the group of devices consisting of cellular telephones, mobile telephones, tablet devices and laptops.

13. The method of claim 7 in which the picture image is created by an object placed in front of a 45° reflecting mirror which is placed over the self facing camera lens on a handheld mobile computing device.

13. The method of claim 8 in which the video image is created by an object placed in front of a 45° reflecting mirror which is placed over the self facing camera lens on a handheld mobile computing device.

14. The method of claim 7 in which the flat panel screen is a large, flat panel monitor such as a television or video monitor.

15. The method of claim 14 in which the quadraplex holographic slide is shared to the flat panel monitor by use of the share screen function on a mobile handheld computing device containing the quadraplex holographic slide.

16. The method of claim 7 in which the inverted pyramid holographic projector is suspended from the ceiling.

17. The method of claim 7 in which the flat panel screen is suspended from the ceiling facing downward, and the pyramid holographic projector is suspended un-inverted directly beneath the flat panel screen such that the holographic presentation is projected to a point somewhat beneath the ceiling.

18. The method of claim 7 in which the selected shape is circular such that a spherical holographic video presentation can be given.

19. The method of claim 7 in which a holographic photographic or video presentation is created for live viewing or for recording and saving as a video or other data format file.

20. The method of claim 7 in which an individual user can create a selfie holographic photographic or video presentation for live viewing or for recording and saving as a video or other data format file.

21. The method of claim 7 in which two (2) or more individual users can communicate in real time holographic chat sessions.

22. The method of claim 7 in which multiple viewers in a given location can experience a single real time holographic multimedia presentation created in a different location.

23. A mobile app for use on a portable, handheld computing device that converts a picture or video image into a holographic multimedia presentation for display using an inverted pyramid holographic projector, the application comprising the following functionality:
Selector means for selection of a picture file or video file for use in the multimedia presentation display;
Image processing means for populating a quadraplex holographic slide with the desired picture file or image file, the quadraplex holographic slide consisting of four identical, rotated and inverted copies of the picture image or video image; and
Display means for transmitting the quadraplex holographic slide from the portable handheld computing device to an inverted pyramid holographic image projector.

24. The mobile app of claim 18 further having functionality for selecting a live video streaming file for use in the multimedia presentation display.

25. The mobile app of claim 8 further having functionality for selecting a picture or video image associated with social media data feed.
